(19) United States
(12) Patent Application Publication
(10) Pub. No.: US 2003/0118281 A1
(43) Pub. Date: Jun. 26, 2003

(54) Method and system for pass band flattening and broadening of transmission spectra using grating based optical devices

(76) Inventors: Li Chen, Fremont, CA (US); Danny (Dejin) Yu, Fremont, CA (US); William (Wei) Yang, Fremont, CA (US); Charlie (Shu) Zhang, Fremont, CA (US); Jie Yang, Fremont, CA (US)

Correspondence Address: OPPENHEIMER WOLFF & DONNELLY, P. O. BOX 10356, PALO ALTO, CA, 94303, US

(21) Appl. No.: 10/313,150

(22) Filed: Dec. 6, 2002

Related U.S. Application Data
(60) Provisional application No. 60/338,858, filed on Dec. 7, 2001.

(51) Int. Cl. G02B 6/293; G02B 6/34

(52) U.S. Cl. 385/24; 385/37

(57) ABSTRACT

A device for expanding an operable wavelength band of an optical component is disclosed. The device has an optical grating configured to receive a wavelength division multiplexed optical signal. The optical grating is configured to separate the optical signal into two wavelength bands separated by a prescribed wavelength difference. The device has a focusing lens system to focus the two wavelength bands onto a receiving surface. The two wavelength bands are separated on the receiving surface by the prescribed wavelength difference in order to expand the wavelength band of the WDM signal.

### RELATED APPLICATIONS

This application claims priority to U.S. Provisional Patent Application Serial No. 60/338,858, filed on Dec. 7, 2001 entitled PASS-BAND FLATTENING AND BROADENING METHODS AND TECHNIQUES FOR FREE-SPACE GRATING-BASED DENSE WAVELENGTH DIVISION MULTIPLEXING DEVICES, the contents of which are incorporated herein by reference.

Furthermore, the present application claims priority to U.S. patent application Ser. No. 10/185,586, filed Jun. 28, 2002, entitled METHODS AND DESIGNS FOR ACHIEVING WIDE WAVELENGTH PASS-BAND IN OPTICAL COMMUNICATION DEVICES, which claims priority to U.S. Provisional Patent Application Serial No. 60/301,958, filed on Jun. 28, 2001, entitled METHODS AND DESIGNS FOR ACHIEVING WIDE WAVELENGTH PASS-BAND IN OPTICAL COMMUNICATION DEVICES, the contents of both applications being incorporated herein by reference.

### BACKGROUND OF THE INVENTION

1. Field of the Invention

The present invention relates generally to systems and methods for flattening and broadening the pass band of transmission spectra, and more particularly to systems and methods for using free-space grating based dense wavelength division multiplexing devices for flattening and broadening the pass band of transmission spectra.

2. Description of the Prior Art

Fiber optic networks are becoming increasingly popular and important for high-speed and large-capacity data transmission. These networks are continuously growing due to the explosive expansion of telecommunications and computer communications, especially in the area of the Internet. This has created a dramatic increase in the volume of worldwide data traffic and has placed an increasing demand for communication networks to provide increased bandwidth. To meet this demand, fiber-optic (light wave) communication systems have been developed to harness the enormous usable bandwidth (tens of tera-Hertz) of a single optical fiber transmission link. Because it is impossible to exploit all of the bandwidth of an optical fiber using a single high capacity channel, wavelength division-multiplexing (WDM) fiber-optic systems have been developed to provide high-capacity transmission of multi-carrier signals over a single optical fiber by channeling the bandwidth of the fiber. In accordance with WDM technology, a plurality of superimposed concurrent signals are transmitted on a single fiber wherein each signal has a different wavelength. WDM technology takes advantage of the relative ease of signal manipulation in the wavelength, or optical frequency domain, as opposed to the time domain. In WDM networks, optical transmitters and receivers are tuned to transmit and receive on a specific wavelength such that many signals operating on distinct wavelengths share a single fiber.

Wavelength multiplexing devices are commonly used in fiber-optic communications system to generate a single multi-carrier communication signal stream from a plurality of concurrent signals having different wavelengths received from associated sources or channels for transmission via a single fiber. At the receiving end, wavelength division demultiplexing devices are commonly used to separate the composite wavelength signal into the original signals having different wavelengths.

Some of the most important components in WDM system are demultiplexers, multiplexers, optical add/drop multiplexers (OADM), and wavelength-selective switches. It is advantageous to have wide wavelength pass bands for these components without degrading the signal and increasing the insertion loss of the devices.

Furthermore, it is advantageous to have a wavelength demultiplexer with a wide pass band because there is always some offset to the ITU wavelength grid. Although the operating wavelength for each of the transmitter lasers is tuned to the ITU grid wavelengths as close as possible when manufactured, there is always some offset to the ITU wavelength grid due to mechanical misalignment and aging. Accordingly, the wider the pass window, the more tolerant the laser offset specification can be and the easier for the system to be adjusted. Secondly, a wider pass band would allow for some drift of the laser center wavelengths and the center wavelength of the pass band itself such that the center wavelength would be able to walk out the passing window of the demultiplexer. Thirdly, the wider the relative pass band, the flatter the pass window will be. Therefore, when many components are cascaded in series, the total pass band shape will not deteriorate quickly and the signal can travel farther without re-conditioning.

### SUMMARY OF THE INVENTION

In accordance with the present invention, there are provided methods to design and manufacture optical components with wide pass bands by flattening the pass band shapes of optical components. A design process of the present invention produces wide pass band optical components with multiple optical functions in a single package. The present invention provides a manufacturing process that produces wide pass band optical components with low insertion loss and good device flexibility with large volume capacity with far fewer process steps and equipment. Furthermore, the present invention provides free-space DWDM devices that are easy to manufacture in large quantities using components that are easy to manufacture.

An embodiment of the present invention provides a method and process for manufacturing wide pass band optical components for fiber-optic networks and methods and processes for making bulk (free-space) grating-related optical components within or based on glass materials. The present invention provides processes with detailed descriptions of special gratings and optical structures to form optical components for manipulating light beam distributions, in terms of both spatial and spectral distributions. The components include a grating means with dual or multi-grating structures for diffracting an optical beam. The grating means are made by combining multi-grating structures into one grating component. Other components are beam shaping means made from optical materials, micro optical array components and means for shaping the beam through optical components with phase structures. The present invention provides methods to manufacture WDM optical components with wide pass bands at highly repeatable manufacturing processes at lower cost.

### BRIEF DESCRIPTION OF THE DRAWINGS

These, as well as other features of the present invention, will become more apparent upon reference to the drawings wherein:

FIGS. 1(a) and 1(b) show a prior art demultiplexer and spectrum;

FIG. 2 is a graph illustrating the concept of having a wider wavelength pass band for a given channel on the demultiplexer transmission spectrum;

FIG. 3(a) is a schematic diagram illustrating a micro-lens array with cylindrical lenses;

FIG. 3(b) is graph for the spectrum generated by the device shown in FIG. 3(a);

FIGS. 4(a) and 4(b) illustrate a micro-lens array for generating a wide wavelength pass band;

FIGS. 5(a)-5(c) illustrate the process of generating a wide wavelength pass band by combining two closely-spaced sub-spectra;

FIGS. 6(a) and 6(b) illustrate the process of generating wide wavelength pass band with a double exposure or double ruling on both transmission and reflection gratings;

FIGS. 7(a) and 7(b) illustrate grating components;

FIG. 8 is a diagram showing two parallel vertical gratings with different periods for producing a desired beam shape;

FIGS. 9(a)-9(d) illustrate a grating with a thin lens or a glass prism to generate the desired beam shape;

FIG. 10 is an example illustrating broadened and flattened pass band profiles by using two gratings;

FIGS. 11(a)-11(c) illustrate a grating with a period linearly changing to achieve the desired beam shape.

### DETAILED DESCRIPTION OF THE PREFERRED EMBODIMENTS

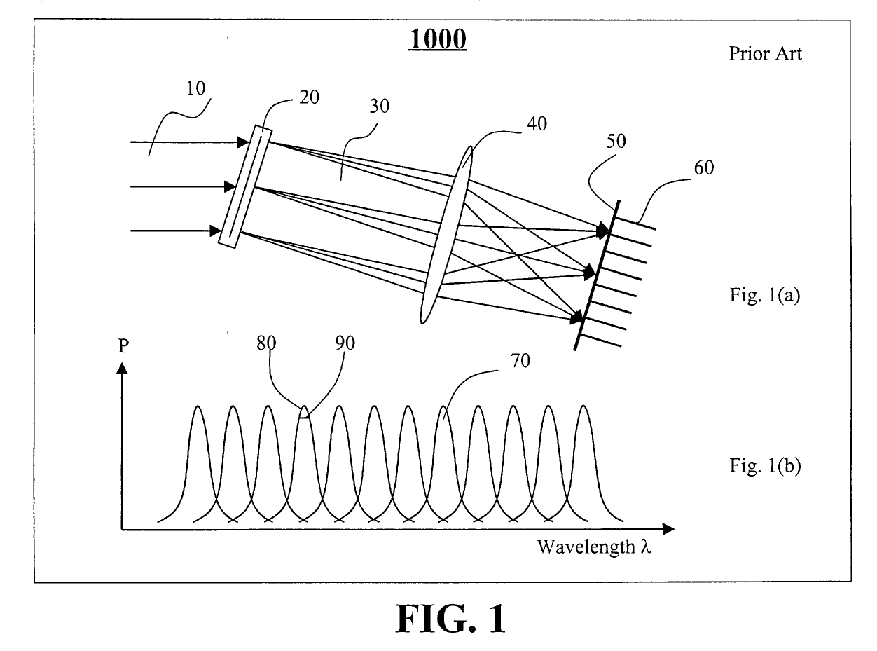

Referring now to the drawings wherein the showings are for purposes of illustrating preferred embodiments of the present invention only, and not for purposes of limiting the same, FIG. 1 illustrates a prior art multiplexer/demultiplexer (Mux/Demux) device 1000. When the device 1000 operates as a demultiplexer an optical beam 10 containing a plurality of wavelengths is transmitted into an angular dispersion element 20 such as a free-space grating which separates the optical beam 10 into optical wavelength spectrum. The dispersed beam 30 is focused by a focusing lens 40 onto a fiber array 50 that has a series of optical fibers 60. The fiber assembly 50 is made by stacking one or more rows of substantially closely spaced, end-flushed and AR (anti-reflection) coated optical fibers 60 in well-aligned silicon V-grooves.

The angular dispersion element 20 has a diffractive element and a substrate. The dispersion element is described in U.S. Pat. Nos. 6,108,471 and 6,275,630B1, the contents of which are incorporated herein by reference. The substrate is made from a low scattering glass material with the surface coated with an anti-reflection coating to enhance the passage of the optical beam. The diffractive element is made with a holographic technique utilizing photosensitive media that has a sufficient thickness. Preferably, the diffactive element is made with a volume hologram so that the diffractive efficiency is high and the operating wavelength range is broad. The photosensitive media are preferably materials that are able to achieve high spatial resolution in order to generate high groove density thus high spectral resolution for DWDM applications. The photosensitive media are preferably materials that have low light scattering, low optical noise and are capable of transmitting the wavelengths of interest to fiber optic networks. One preferred example of such photosensitive media is dichromated gelatin (DCG).

Referring to FIG. 1(b), a transmitted signal spectrum 70 received by the fiber array 60 is illustrated with peaks 80 having a Gaussian shaped pass band profile on the top portion of the spectrum 70 and a pass band region 90. This phenomenon not only happens in the transmission grating-based multiplexer-demultiplexer apparatus 1000, but is also common to reflection grating-based multiplexer-demultiplexer apparatuses.

The Gaussian shaped pass band profile is not desirable in many optical communications systems because it is preferred to have a wavelength demultiplexer with a wide pass band and a flat top profile. A wider pass window is desired because although the operating wavelength for each transmitter laser is tuned as close as possible to the ITU grid wavelengths when manufactured, there are always some offsets to the ITU wavelength grid. The more tolerance on the laser offset specification, the easier for the system to be operated. Secondly, as there is always some wavelength drift in terms of the laser center wavelengths and the center wavelength of the pass band itself. The wider pass band allows the system to tolerate large drifts so that the center wavelength can walk off the pass window of a demultiplexer.

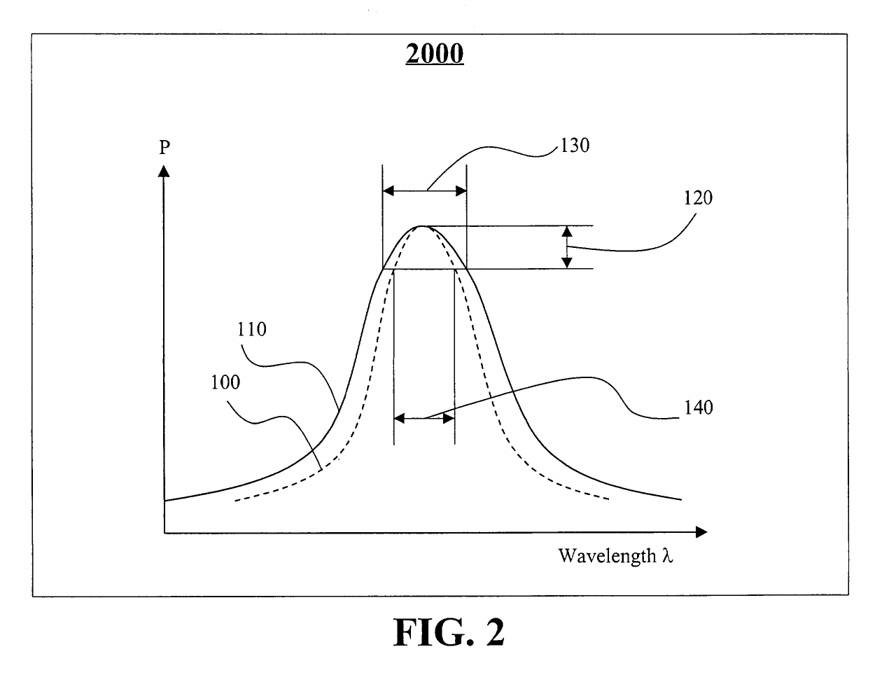

The transmission spectra 100 and 110 for two optical beams is shown in FIG. 2. The spectrum 100 has a relatively narrow pass band 140 with a smaller spectral width than transmission spectrum 110 with a relatively wider pass band 130 and larger spectral width. The vertical measurement of the spectrum is the insertion loss 120 and has a height from the peak to a point 0.5 dB or 1 dB downward. The pass bands 130, 140 are measured in terms of the two spectra 110, 100 respectively. The pass band 130 is wider than pass band 140 for the same downward insertion loss 120 because the two spectra have different shapes. Because the spectrum 110 has a wider pass band 130, the shape of spectrum 110 is more desirable than that of spectrum 100.

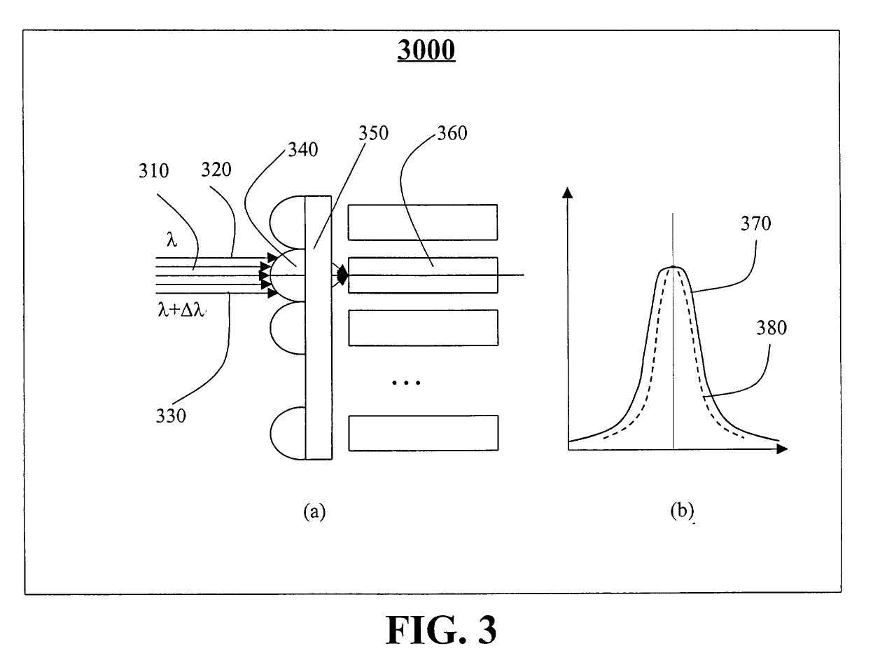

Referring to FIG. 3(a), a micro-lens array 350 is shown to couple the diffracted wavelength components from the focusing lens 40 into the fiber array 60. The micro-lens array 350 not only increases the coupling efficiency but also widens the pass band of the transmission spectrum of a receiving fiber. A band of incident field optical components 310 having wavelengths ranging from λ 320 to λ+Δλ 330 are received by the micro-lens array 350 and focused to the center of an optical fiber 360. A broadened spectrum 370 of the optical components 310 with a broad Gaussian profile is shown in FIG. 3(b). For comparison, the Gaussian distribution of spectra 380 is without the use of micro-lens array 350. The micro-lens array 350 collects the field components 310 ranging from λ 320 to λ+Δλ 300 and generates an elliptical spot on the receiving facet of the fiber 360. The micro-lens assembly 350 in FIG. 3(a) is placed in front of the receiving fiber array. The micro-lenses 340 of the micro-lens array 350 are fabricated by photo-lithographic techniques and are commonly. spherical lenses. When used in multiplexer/demultiplexer devices, cylindrical lenses are preferred. The cylindrical shape of the micro-lens 340 in the perpendicular dimension results in a radius of infinity. The surface of a micro-lens 340 can also be non-spherical, or even arbitrary such that the field components 310 within the pass band wavelength range are equally coupled into the fiber 360.

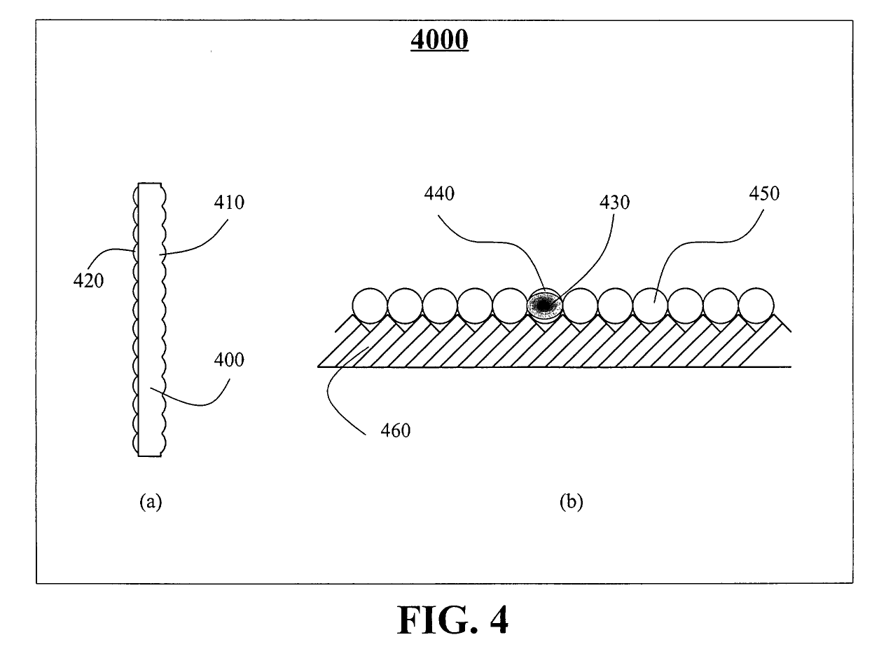

Referring to FIG. 4(a), another example of a micro-lens array 400 with a receiving fiber array 410 is illustrated. The micro-lens array 400 has receiving microlenses 420 which each receive spectral components 310 (FIG. 3). The receiving fiber array 410 is more fully illustrated in FIG. 4(b) wherein a plurality of optical fibers 450 are aligned on silicon substrate 460 with V grooves. Each one of the optical fibers 450 corresponds to one of the micro-lenses 420. The micro-lenses 420 focus the spectral components 310 into an elliptical spot 440 having a Gaussian distribution to produce an intensity spot 430.

The use of micro-lens array 350 can broaden the pass bandwidth to a finite extent but does not obtain a desired flat top to the pass band. Because the size of a micro-lens is already quite small, further diffraction will appear such that the focusing area is a finite-size spot rather than a point. A better approach to achieve a flat top pass band is to modify the structure of the diffraction elements so that the desired shape of the transmission spectrum can be produced.

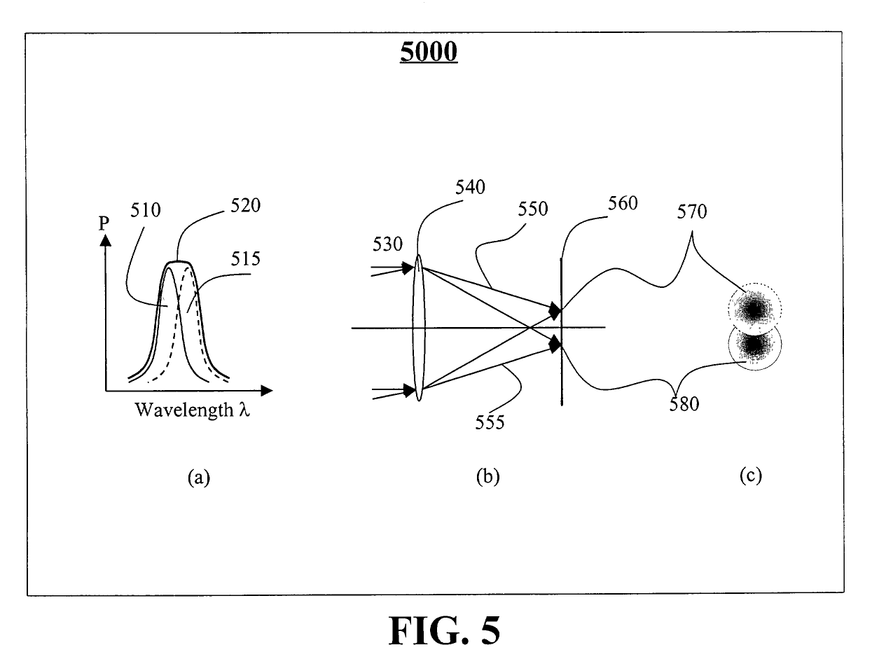

Referring to FIG. 5, a flat top pass band profile 520 is achieved by combining two sub-spectra 510 and 515 wherein each sub-spectra 510, 515 is Gaussian in nature and has a substantially narrow pass bandwidth. The two similar sub-spectra 510, 515 must be separated in wavelength by a proper amount in order to achieve the desired flat top pass band profile 520. A dispersion element and an associated optical system can generate the two sets of sub-spectra with the proper wavelength shift, as will be further explained below. Referring to FIGS. 5(b) and 5(c), the typical optical paths and field distributions for. the two sub-spectra 510, 515 at the same wavelength are shown. The angular dispersed optical beams 530 are incident on a focusing lens 540. The optical beams 530 contain the two sets of spectra 510, 515 that are slightly shifted in angle and accordingly in wavelength by a corresponding small amount Δλ. After the focusing lens 540, the two sets of spectra 510, 515 at the corresponding wavelength (e.g., 1530.33 nm) are focused to generate beams 550 and 555 with a small separating angle. The beams 550 and 555 form two spots 570 and 580 on a receiving plane 560. The angular distance between beams 550 and 555 corresponds to a wavelength separation of Δλ. Consequently, the two wavelength components with a wavelength difference Δλ will overlap at the same receiving point on the receiving plane 560 because the same wavelength components coming from the different spectra are separated in space. The two overlapped spectra will give rise to the flattened pass band spectrum profile 520 shown in FIG. 5(a).

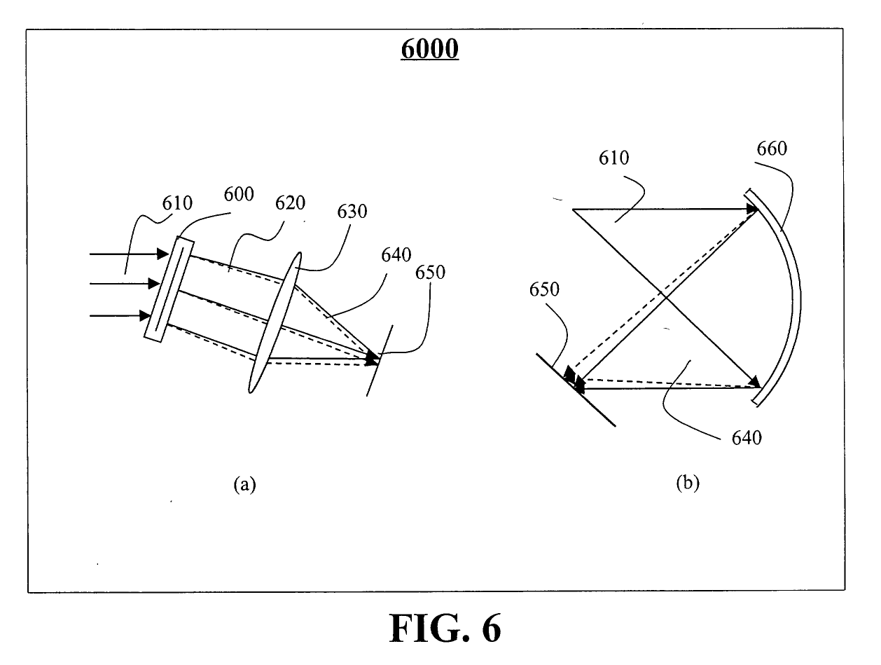

Referring to FIG. 6, the process of generating a wide wavelength pass band with a double ruling on both a transmission and reflection grating is shown. A ruled transmission grating 600 and a reflective grating 660 have two sets of grooves with slightly different periods. The grooves can be made or replicated with two master pieces and can be used for generating the wide wavelength pass bands in the manner described in FIG. 5. Specifically, referring to FIG. 6(a), an incoming collimated optical beam 610 having a wavelength λ is transmitted through the compound transmission grating 600 at a prescribed angle and is diffracted to another angle by a diffraction element of the grating 600. Because the diffraction element has two sets of gratings with slightly different groove densities, the energy of an outgoing optical beam 620 is redistributed and diffracted at two slightly different directions. A lens system 630, such as bulk lenses, micro-lenses or combination thereof, focuses the outgoing optical beam 640 onto a receiving surface 650. Because the diffraction angle of the beam 640 is a function of wavelength, two wavelength components, λ and λ+Δλ, will be focused onto the same spatial point on the receiving surface 650 and a result in the two overlapped spots 510 and 515 in space (FIG. 5). The combination of the energy distribution from the spots 510 and 515 will give an image spot that has the energy distribution 520 as shown in FIG. 5(a). The flattened spectrum formed by combining spots 510 and 515 in this manner represents a widened wavelength pass band.

Referring to FIG. 6(b), a reflection grating 660 is used instead of a transmission grating 600. The reflection grating 600 is formed with a curved reflective surface with a prescribed radius so that the diffracted beams can be effectively focused onto the receiving surface 650 into two spots.

The transmission grating 600 can be formed with a holographic grating element with a double-exposure (twice exposures) process. The grating 600 is made in such a way that the diffraction element contains two or more sets of diffraction gratings with slightly different groove densities. An example of a way to make such multi-grating diffractive element is to take multiple laser exposures to a photosensitive media using a holographic technique. Each exposure is performed at a slightly different angle so that different interference patterns are recorded in the photosensitive medium. Accordingly, gratings with slightly different groove densities are formed. The multiple exposures can be applied to the whole area of the photosensitive media so that multiple gratings are formed in the same area, or the exposures can be applied to different ranges of the photosensitive media so that different gratings are formed in different portions of the diffractive element.

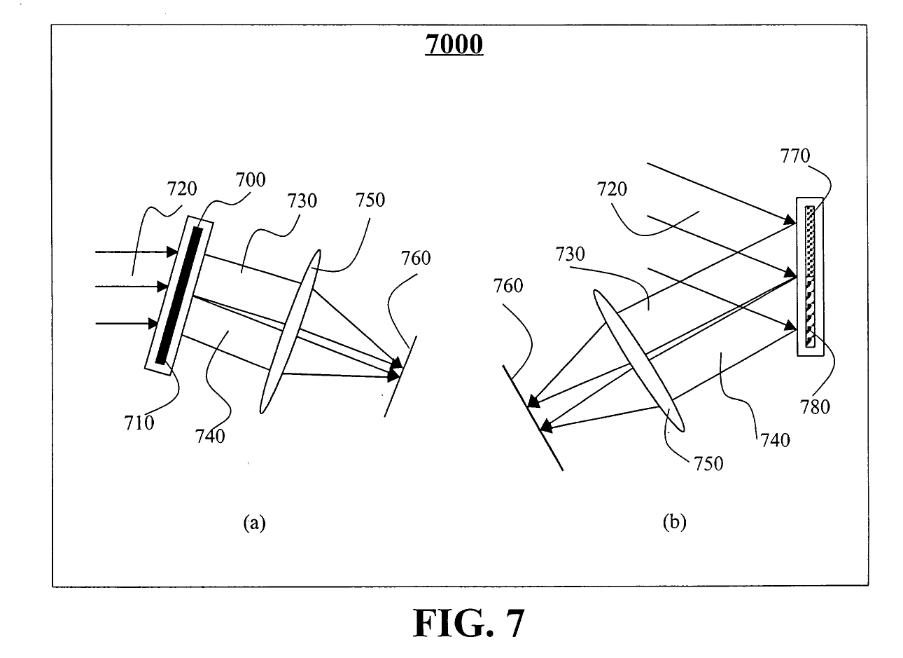

Referring to FIG. 7, the process of generating a wide wavelength pass band with a transmission or reflection grating having two or more ranges of grooves with slightly different periods is shown. FIG. 7(a) illustrates an optical device using a two-range holographic transmission grating. The holographic grating consists of two slightly different diffractive elements 700 and 710. When an incoming collimated optical beam 720 having a wavelength X is transmitted through the grating elements 700 and 710, the beam 720 is diffracted into one direction as beam 730 and into a different direction as beam 740. A lens system 750, such as bulk lenses, micro-lenses or combination thereof, focuses the beams 730 and 740 onto a receiving surface 760. The beams 730 and 740 form two spots with a small spatial separation but having a wavelength X as shown and described for FIG. 5. Because the diffractive elements 700 and 710 have slightly different groove densities, the difference between the directions of the beams 730 and 740 is small but large enough to separate the focal spots. The separation between the two spots is at the desired amount that corresponds to a wavelength difference Δλ, thereby resulting in a wider wavelength pass band capability.

A two-range holographic reflection grating is shown in FIG. 7(b). The reflection grating is similar to the transmission grating shown and described for FIG. 7(a) and has two slightly different diffractive elements 770 and 780. The incoming collimated optical beam 720 impinges upon the diffractive element 770 and 780 and is reflected and diffracted into one direction as beam 730 and into a different direction as beam 740. The lens system 750 focuses the beams 730 and 740 onto the receiving plane 760 as described for FIG. 7(a).

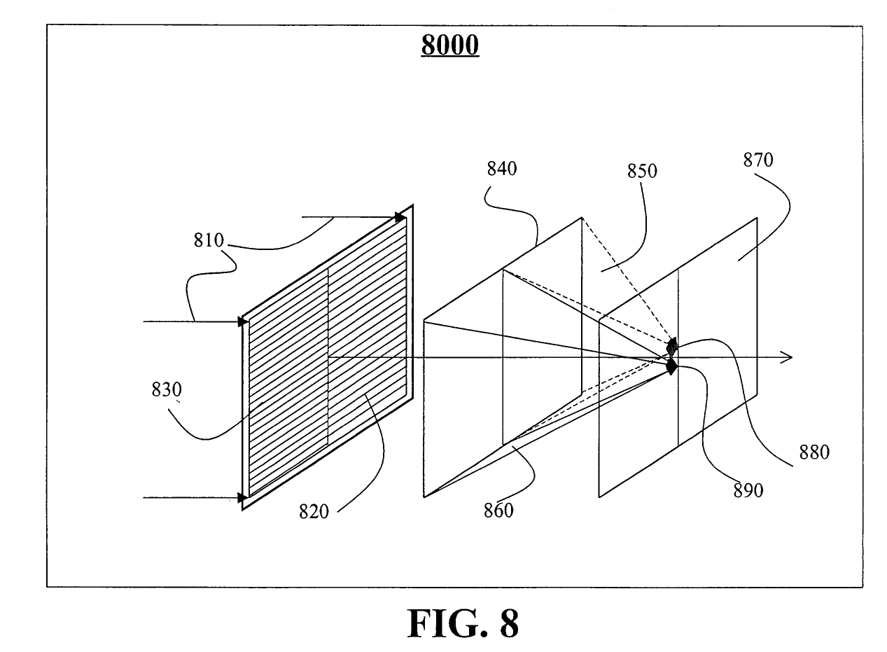

An embodiment of the present invention is illustrated in FIG. 8 wherein two diffraction elements 820, 830 having groove periods slightly different are used. The two diffraction elements 820, 830 are arranged such that the separation line is perpendicular to the groove direction. The grooves of the two diffraction elements are in the horizontal direction. A collimated incident beam 810 is diffracted by the two diffraction elements 820 and 830 to form two groups of diffracted beams which are then transmitted through a focusing lens unit 840. The two groups of focused beams 850 and 860 from the focusing lens unit 840 have the same wavelength λ. The focused beams 850, 860 appear as respective spots 880, 890 on a receiving plane 870 with a small separation in the vertical direction, as seen in FIG. 8. The separation corresponds to the wavelength difference Δλ. If a receiving fiber is centered on the receiving plane at the location of the spots 880, 890, the sub-spectra generated thereby can be transmitted by the optical fiber. The scattering generated by the central separation zone between the two gratings is perpendicular to the diffraction direction of gratings and does not contribute to the output signals. As a result, crosstalk between channels does not worsen. Furthermore, if the maximum number of grooves is provided, then the largest spectral resolution can be obtained.

A united holographic grating assembly can be made by a double-exposure process to form a grating assembly having the two grating elements 820, 830 described above. The grating assembly with elements 820 and 830 is made in such a way that the two diffraction elements are formed side by side whereby each element 820, 830 occupies one half of the space of the grating assembly. The two sets of diffraction gratings 820, 830 are each formed with slightly different groove densities. An example of a way to make such a grating assembly is to perform multiple laser exposures on a photosensitive medium using holographic techniques. Each exposure will be performed at a slightly different angular setup so that different interference patterns are recorded on different parts of photosensitive medium with slightly different groove densities. The multiple exposures are applied to one half of the photosensitive medium first and then to the other half of the medium so that the two gratings are formed in two respective areas.

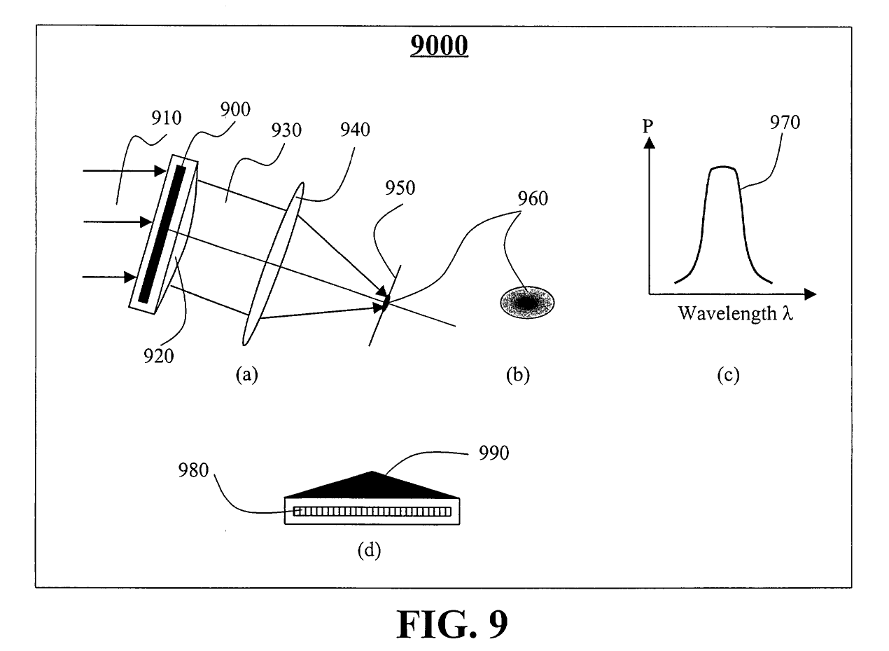

It is also possible to generate similar wide pass band results with either a cylindrical or symmetrical roof prism, as seen in FIG. 9. Specifically, FIG. 9(a) illustrates the process of generating a wide wavelength pass band with a holographic grating assembly 900 having a bulk cylindrical lens 920. An incoming collimated optical beam 910 having a wavelength λ is transmitted through the grating 900 at a prescribed angle and is diffracted to a different angle by a diffractive element of the grating 900. The cylindrical lens 920 has a slight focusing or defocusing power after the diffractive element such that the optical paths of beams transmitted therethrough will be modified. The radius for the surface of the cylindrical lens 920 is determined by a calculation based on the desired pass band width requirement. Due to the focusing effects of the perpendicular cylindrical dimension of the lens 920, the energy of the transmitted optical beam 930 is redistributed. The transmitted optical beam 930 is propagated through a lens system 940 such as bulk lenses, micro-lenses or combination thereof. The lens system 940 focuses the outgoing beam 930 onto a receiving surface 950 to form an elongated spot 960 having a wavelength λ. The energy distribution of spot 960 has the same energy distribution of spectra 970 shown in FIG. 9(c).

FIG. 9(d) illustrates a roof prism 990 to generate the wide wavelength pass band in conjunction with a transmission grating 980. The roof prism 990 with transmission grating 980 is used similar to the grating assembly 900 having a bulk cylindrical lens 920. Specifically, the roof prism 990 is used in place of the grating assembly 900 in order to generate the spectra 970.

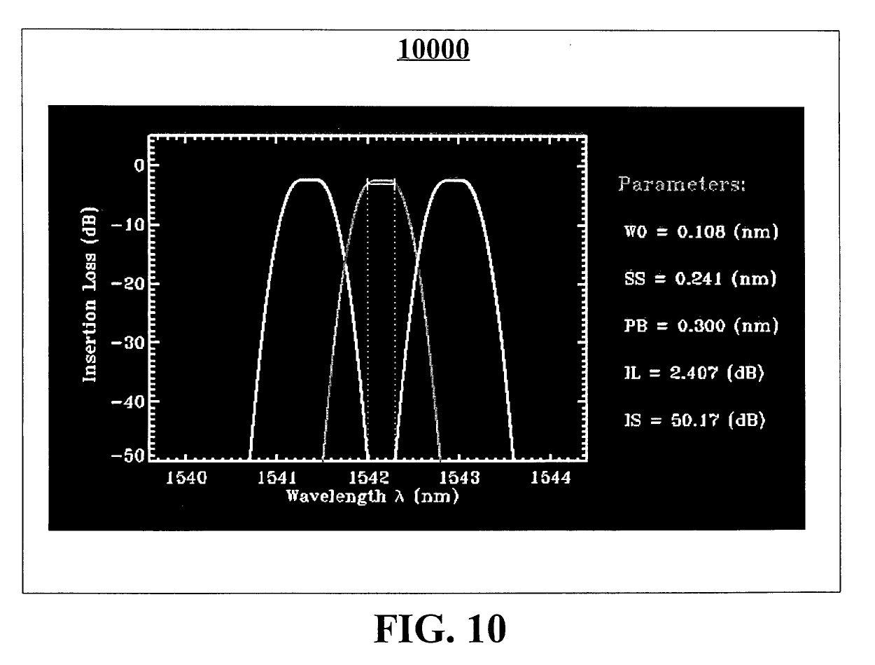

An example of a numerical simulation for the present invention is shown in FIG. 10. Specifically, a 100 GHz channel spacing demultiplexer device, as shown in FIG. 8, is simulated. As seen in FIG. 10, a broadened pass band spectrum with a substantial flat top profile is obtained from the combination of the two narrow sub-spectra. In this example, the resulting pass bandwidth at a 0.5 dB down power point is about 0.3 nm. Each sub-spectra has a pass bandwidth 0.108 nm at the 0.5 dB down point. The spectral separation between the two sub-spectra is required to be 0.241 nm. With this configuration, the channel isolation is increased significantly and the isolation between adjacent channels is as high as 50.17 dB.

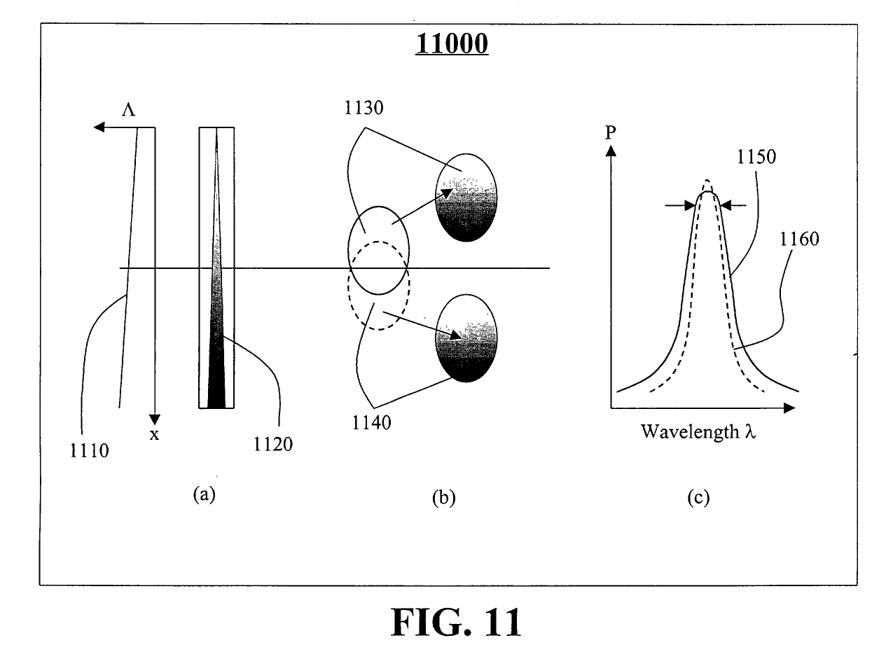

In another embodiment of the present invention, a wide wavelength pass band can be achieved by using a special grating with a linearly changing groove density. Referring to FIG. 11(a), the changing period Λ 1110 of the groove density for the grating as a function of distance perpendicular to the grooves is shown as schematic plot 1120. The difference between the periods of the grooves at the two ends of the grating is small. The amount of the difference in the periods of the grooves is determined by the desired spectrum shape. When an optical beam having a plurality of wavelengths is diffracted by such a grating, two nearby wavelengths with a difference Δλ will be generated and form two elongated spots 1130 and 1140 on the receiving plane (FIG. 11(b)). The two spots 1130 and 1140 have substantial overlapping spectra in the common area. The combination of the spots 1130 and 1140 in the common area generates a widened pass band spectrum 1150 as shown in FIG. 11(c). As can be seen in FIG. 11(c), the spectrum 1150 is wider than the spectra 1160 generated from a grating with an average grating period.

Additional modifications and improvements of the present invention may also be apparent to those skilled in the art. Thus, the particular combination of parts described and illustrated herein is intended to represent only certain embodiments of the present invention, and is not intended to serve as limitations of alternative devices within the spirit and scope of the invention.

What is claimed is:

1. A device for expanding an operable wavelength band of an optical component receiving a wavelength division multiplexed (WDM) signal, the device comprising:
an optical grating configured to receive and separate the input WDM signal into two groups wherein each group contains a full spectrum of wavelengths and each of the two groups are shifted by a prescribed wavelength difference;
a focusing lens system in optical communication with the optical grating; and
a receiving surface in optical communication with the focusing lens;
wherein the two groups of signals separated by the optical grating are focused on the receiving surface and separated by the prescribed wavelength difference such that the wavelength band of the WDM signal is expanded.

2. The device of claim 1 wherein the optical grating is a two-range diffraction grating that separates the WDM signal into two different ranges.

3. The device of claim 1 wherein the focusing lens system comprises micro-lenses.

4. The device of claim 1 wherein the focusing lens system comprises bulk lenses.

5. The device of claim 1 wherein the optical grating comprises two gratings having different groove densities.

6. The device of claim 1 wherein the receiving surface comprises an optical fiber to receive the two wavelength bands.

7. The device of claim 1 wherein the optical grating comprises two gratings with a separation line perpendicular to the groove direction.

8. A device for expanding an operable wavelength band of an optical component receiving a wavelength division multiplexed (WDM) signal, the device comprising:
a reflective optical grating configured to separate and reflect the WDM signal into two groups of spectra separated by a prescribed wavelength difference;
a focusing lens system in optical communication with the optical grating; and
a receiving surface in optical communication with the focusing lens;
wherein the two spectra separated and reflected by the optical grating are focused on the receiving surface separated by the prescribed wavelength difference such that the pass band transmission spectrum of the WDM signal is expanded.

9. The device of claim 8 wherein the optical grating is a two-range holographic reflective grating that separates and reflects the WDM signal into two different groups.

10. The device of claim 8 wherein the focusing lens system comprises micro-lenses.

11. The device of claim 8 wherein the focusing lens system comprises bulk lenses.

12. The device of claim 8 wherein the optical grating comprises two gratings having different groove densities.

13. The device of claim 8 wherein the receiving surface comprises an optical fiber to receive the two wavelength bands.

14. The device of claim 8 wherein the optical grating comprises two gratings with a separation line perpendicular to the groove direction.

15. A method for expanding an operable wavelength band of an optical component receiving a wavelength division multiplexed (WDM) signal with a device having an optical grating, a focusing lens system and a receiving surface, the method comprising the steps of:
a) separating the WDM signal into two wavelength bands separated by a prescribed wavelength difference with the optical grating; and
b) focusing the two wavelength bands with the focusing lens system onto the receiving surface such that the wavelength bands are separated by the prescribed wavelength difference such that the pass band spectrum of the WDM signal is expanded.

16. The method of claim 15 wherein in step (a) the WDM signal is separated by a two-range reflective or transmission diffraction grating.

17. The method of claim 15 wherein the two wavelength bands are focused with a lens system comprising microlenses in step (b).

18. The method of claim 15 wherein the two wavelength bands are focused with a lens system comprising bulk lenses in step (b).

19. The method of claim 15 wherein in step (a) the WDM signal is separated into two wavelength bands with an optical grating having two gratings with different groove densities.

20. The method of claim 15 wherein the receiving surface has an optical fiber and the method further comprises the step of transmitting the two wavelength bands through the optical fiber.

21. The method of claim 15 wherein in step (a) the WDM signal is separated into two wavelength bands with an optical grating having two sub-gratings with a separation line perpendicular to the groove direction.

22. A method for expanding an operable wavelength band of an optical component receiving a wavelength division multiplexed (WDM) signal with a device having an optical grating, a focusing lens system and a receiving surface, the method comprising the steps of:
a) separating the WDM signal into two wavelength bands separated by a prescribed wavelength difference with the optical grating;
b) reflecting the two wavelength bands with the optical grating; and
c) focusing the two wavelength bands with the focusing lens system onto the receiving surface such that the wavelength bands are separated by the prescribed wavelength difference such that the pass band spectrum of the WDM signal is expanded.

23. The method of claim 22 wherein in steps (a) and (b) the WDM signal is separated and reflected by a two-range holographic reflective grating.

24. The method of claim 22 wherein the two wavelength bands are focused with a lens system comprising microlenses in step (c).

25. The method of claim 22 wherein the two wavelength bands are focused with a lens system comprising bulk lenses in step (c).

26. The method of claim 22 wherein in step (a) the WDM signal is separated into two wavelength bands with an optical grating having two gratings with different groove densities.

27. The method of claim 22 wherein the receiving surface has an optical fiber and the method further comprises the step of transmitting the two wavelength bands through the optical fiber.

28. The method of claim 22 wherein in step (a) the WDM signal is separated into two wavelength bands with an optical grating having two gratings with a separation line perpendicular to the groove direction.

29. The method of claim 22 wherein in step (a) the WDM signal is separated into two wavelength bands with an optical grating having two gratings with a separation line parallel to the groove direction.

30. A system for expanding the optical wavelength band of a wavelength division multiplexed (WDM) signal, the system comprising:
grating means for receiving the WDM signal and separating the WDM signal into two wavelength bands separated by a prescribed wavelength difference;
focusing means in optical communication with the grating means for focusing the two wavelength bands; and
receiving means in optical communication with the focusing means for receiving the two wavelength bands separated by the prescribed wavelength difference such that the pass band spectrum of the WDM signal is expanded.

31. The device of claim 30 wherein the grating means is a transmission optical grating.

32. The device of claim 30 wherein the grating means is a reflective optical grating.

33. The device of claim 30 wherein the receiving means comprises an optical fiber for receiving the two wavelength bands of the WDM signal.

34. A system for expanding the optical wavelength band of a wavelength division multiplexed (WDM) signal, the system comprising:
grating means for receiving and diffracting the WDM signal;
prism means for separating the diffracted signal into two wavelength bands separated by a prescribed wavelength difference;
focusing means in optical communication with the prism means for focusing the two wavelength bands; and
receiving means in optical communication with the focusing means for receiving the two wavelength bands separated by the prescribed wavelength difference such that the pass band spectrum of the WDM signal is expanded.

35. The system of claim 34 wherein the prism means is a cylindrical or roof prism.
